(19) United States
(12) Patent Application Publication
(10) Pub. No.: US 2025/0005548 A1
(43) Pub. Date: Jan. 2, 2025

(54) METHOD FOR ESTABLISHING A REMOTE COMMUNICATION SESSION

(71) Applicant: NCR Voyix Corporation, Altanta, GA (US)

(72) Inventor: Justin Long, Kennesaw, GA (US)

(21) Appl. No.: 18/217,237

(22) Filed: Jun. 30, 2023

(51) Int. Cl. G06Q 20/10

(52) U.S. Cl. CPC G06Q 20/108

(57) ABSTRACT

A customer transmits a service request message to a central controller. The controller identifies a second type of communication session participant and a third type of communication session participant that will be required to process the requested service. The controller calculates an aggregated availability parameter for each possible combination of communication session participant in a second queue and communication session participant in a third queue based on second availability parameters and third availability parameters. The controller selects a second communication session participant from the second queue, and a third communication session participant from the third queue. The controller determines if a pre-defined quorum of communication session participants has been reached. The controller initiates the remote communication session between the customer, the second communication session participant, and the third communication session participant. The controller identifies one of the communication session participants to act as a lead communication session participant.

### FIELD OF THE INVENTION

This invention relates to a computer-implemented method for establishing a remote communication session.

### BACKGROUND

It is known for a customer to perform simple financial transactions using an automated teller machine (ATM), or with the assistance of a bank teller in a bank branch. However known approaches do not enable a customer to perform more complex financial transactions.

This invention is aimed at providing an improved method which overcomes at least some of these difficulties.

### SUMMARY

According to the invention there is provided a computer-implemented method for establishing a remote communication session, the method comprising the steps of: receiving a service request message from a first communication session participant, determining a second communication session participant and a third communication session participant based on the service request message, and initiating a communication session between the first communication session participant, the second communication session participant, and the third communication session participant.

The second communication session participant and the third communication session participant may be selected based on the needs or resource requirements to perform the service.

Because the communication session includes both the second communication session participant and the third communication session participant, this ensures that there are more resources available during the communication session to process the requested service. In this manner the method of the invention ensures that it is possible for the first communication session participant to access a wide variety of services during a single communication session, such as complex financial transactions, without being required to wait and without being required to travel to a specific physical location.

The communication session participant may be a person such as an interpreter, or may be a bot or machine. The bot or machine may be selected based on available resources. For example if there is a limited number of possible chat rooms, it may be necessary to wait for one of the chat rooms to become available to provide the required service. It may be necessary to wait for a person such as a teller to become available to participate in the communication session.

It will be appreciated that the method of the invention is suitable for use with more than three communication session participants. The invention is not limited to only having three communication session participants.

The method may comprise the step of selecting the second communication session participant from a second queue of possible communication session participants. By maintaining a queue of possible communication session participants, this minimises the time before the selected communication session participant starts to process the requested service. The method may comprise the step of determining a second availability parameter for each possible communication session participant in the second queue. In this manner the next available communication session participant may be selected for a fast response time to the requested service. The method may comprise the step of selecting the third communication session participant from a third queue of possible communication session participants. By maintaining a queue of possible communication session participants, this minimises the time before the selected communication session participant starts to process the requested service. The method may comprise the step of determining a third availability parameter for each possible communication session participant in the third queue. In this manner the next available communication session participant may be selected for a fast response time to the requested service. The method may comprise the step of determining an aggregated availability parameter for each possible combination of communication session participant in the second queue and communication session participant in the third queue based on the second availability parameters and the third availability parameters. The second communication session participant may be selected and the third communication session participant may be selected based on the aggregated availability parameter. In this manner the availability from both the second queue and the third queue are taken into account when selecting the second communication session participant and the third communication session participant to minimise the time required to process the requested service.

The method may comprise the step of: determining if a pre-defined quorum of communication session participants has been reached, and responsive to the pre-defined quorum being reached, initiating the communication session.

For some service requests it may be beneficial to wait until the quorum has been reached, for example if the communication session participant has a resource or capability that is required for the communication session, such as a video communication connectivity.

The method may comprise the step of determining one of the first communication session participant, the second communication session participant, and the third communication session participant to act as a lead communication session participant. In this manner one of the communication session participants, such as a person or a bot, may take charge of the communication session to lead the communication session.

In the event of two or more communication session participants having the same or compatible communication resources available, the system may perform a negotiation process to determine the optimum communication resource to use.

The first communication session participant may comprise a customer.

The second communication session participant may have a second attribute to perform a second type of service task. The third communication session participant may have a third attribute to perform a third type of service task, the third type of service task being different to the second type of service task. Because the second communication session participant and the third communication session participant may perform different tasks, this ensures that the capabilities available during the communication session are maximised so that the requested service may be processed during a single communication session. The attribute may comprise an authorisation level. The attribute may comprise a skill. The attribute may be related to a service location. The attribute may comprise an application programming interface. The attribute may comprise a credential. The attribute may comprise an identifier. The attribute may comprise a key.

The second communication session participant may comprise at least one of a bank teller, a supervisor, a customer service representative, an interpreter, an automated machine, a machine learning tool, a computer program, a sales professional, an insurance agent, a mortgage agent, an underwriter, a loan specialist, a receptionist, or a pooled resource manager. The method may comprise the step of determining a fourth communication session

participant to be added to the communication session. The fourth communication session participant may be determined based on at least one of data associated with the communication session, or historical data associated with a previous communication session. In this manner the method of the invention may adapt during the communication session to add the fourth communication session participant if considered necessary. This decision may be based on what is being discussed during the current communication session, or based on what occurred in a previous communication session with this customer or with a similar customer. The fourth communication session participant may comprise at least one of a mediator, a notary, an auditor, a consultant, an authenticator, a verifier, or a recorder.

In another aspect of the invention there is provided a data processing system for establishing a remote communication session, the system comprising a processor configured to: receive a service request message from a first communication session participant, determine a second communication session participant and a third communication session participant based on the service request message, and initiate a communication session between the first communication session participant, the second communication session participant, and the third communication session participant.

Because the communication session includes both the second communication session participant and the third communication session participant, this ensures that there are more resources available during the communication session to process the requested service. In this manner the system of the invention ensures that it is possible for the first communication session participant to access a wide variety of services during a single communication session, such as complex financial transactions, without being required to wait and without being required to travel to a specific physical location.

The invention also provides in another aspect a computer program product stored on a non-transitory computer readable storage medium, the computer program product comprising instructions capable of causing a computer system to perform a method of the invention when the computer program product is executed on the computer system.

### BRIEF DESCRIPTION OF THE DRAWING

Embodiments of the invention will be described hereinafter, by way of example only, with reference to the accompanying drawings, in which:

FIG. 1 is a flow diagram of a method according to the invention for establishing a remote communication session,

FIG. 2 is a flow diagram of another method according to the invention for establishing a remote communication session,

FIG. 3 is a flow diagram of another method according to the invention for establishing a remote communication session,

FIG. 4 is a flow diagram of another method according to the invention for establishing a remote communication session, and

FIG. 5 is a flow diagram of another method according to the invention for establishing a remote communication session.

### DETAILED DESCRIPTION

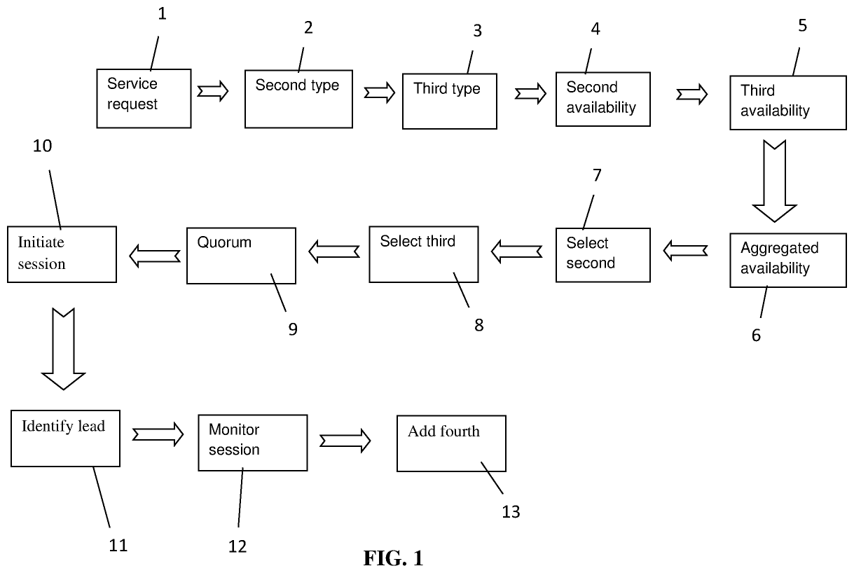

Referring to FIG. 1 there is illustrated a data processing system according to the invention in use. The system comprises a plurality of user devices and a central controller. The system may be employed to establish a remote communication session between a plurality of participants.

A first communication session participant transmits a service request message 1 from a first user device to the central controller. In this case the first communication session participant is a customer. The service requested may be a complex financial transaction, and/or a video communication, and/or a mortgage application, and/or an insurance transaction, and/or a non-financial service.

Based on the service request message 1, the central controller identifies a second type of communication session participant 2 and a third type of communication session participant 3 that will be required to process the requested service during the communication session.

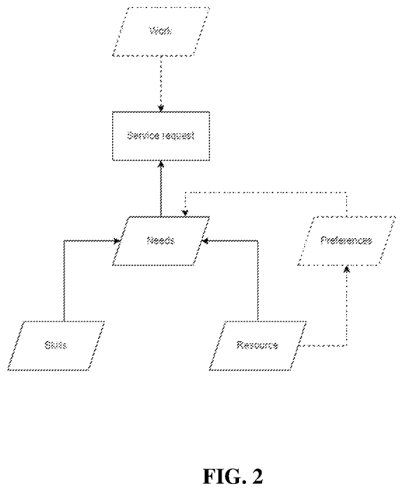

The central controller determines what is required to complete the requested service. The central controller analyses the needs, skills, capabilities, resources required to complete the requested service (FIG. 2).

The central controller accesses a second queue of possible communication session participants, and calculates a second availability parameter 4 for each possible communication session participant in the second queue. Each communication session participant indicates whether the communication session participant is available or unavailable, based on whether the communication session participant is already taking part in a communication session or is already performing a task. The central controller accesses a third queue of possible communication session participants, and calculates a third availability parameter 5 for each possible communication session participant in the third queue. The central controller then calculates an aggregated availability parameter 6 for each possible combination of communication session participant in the second queue and communication session participant in the third queue based on the second availability parameters 4 and the third availability parameters 5. Based on the aggregated availability parameter 6, the central controller selects the second communication session participant 7 from the second queue, and selects the third communication session participant 8 from the third queue. In this manner the system optimises the overall waiting time for the combination of all of the required participants.

The central controller determines if a pre-defined quorum 9 of communication session participants has been reached. When the pre-defined quorum 9 has been reached, the central controller initiates the remote communication session 10 between the first remote communication session participant, the second remote communication session participant, and the third remote communication session participant. The communication session is a collaboration session between the first remote communication session participant, the second remote communication session participant, and the third remote communication session participant. Each resource or capability may initiate a separate communication session in addition to the collaboration communication session, such as a video communication session. During the communication session, the first user device displays the second communication session participant and the third communication session participant to the first communication session participant using a video display. The first user device outputs audio data of the second communication session participant and the third communication session participant to the first communication session participant. The first user device displays a transcription of the communication session in the form of text data to the first communication session participant. The central controller records the verbal discussion of the communication session, for example in the form of audio data or as a text data transcription.

The second communication session participant may be a bank teller, and/or a supervisor, and/or a customer service representative, and/or an interpreter, and/or an automated machine, and/or a machine learning tool, and/or a computer program. Similarly the third communication session participant may be a bank teller, and/or a supervisor, and/or a customer service representative, and/or an interpreter, and/or an automated machine, and/or a machine learning tool, and/or a computer program.

The second communication session participant may have a second attribute to allow the second communication session participant to perform a second type of service task. The third communication session participant may have a third attribute to allow the third communication session participant to perform a third type of service task. The third type of service task is different to the second type of service task.

For example the attribute may be a transaction limit or an authorisation level. In this case the second communication session participant may be a bank teller with a lower transaction limit/authorisation level to enable the second communication session participant to process financial transactions below a pre-defined threshold value, such as $10,000. The third communication session participant may be a supervisor with a higher transaction limit/authorisation level to enable the third communication session participant to process financial transactions of any value.

As another example the attribute may be a skill, such as translating from one language into another language. In this case the second communication session participant may be a bank teller with an ability to communicate with a customer in one language, for example in English. The third communication session participant may be an interpreter with language skills necessary to communicate with a customer in one language, for example in Spanish, and to translate into another language, for example into English, to communicate with the bank teller to allow the requested service to be processed.

As another example the third communication session participant may be a quality assurance specialist that is auditing how the second communication session participant, such as a bank teller, is performing.

As another example the third communication session participant may be a witness or notary to a financial transaction.

As another example the third communication session participant may be an additional co-signer or trustee on a bank account.

As another example the third communication session participant may be a bot that joins the communication session to provide chat functionality if required.

Each communication channel application, which the communication session participants are using, uses the attributes that the communication channel application is aware of and ignores any attributes not recognized. This allows the system to maintain a high level of compatibility between communication session participants.

The central controller identifies one of the communication session participants, either the first communication session participant or the second communication session participant or the third communication session participant, to act as a lead communication session participant 11.

The central controller monitors the communication session 12. Based on data associated with the current communication session, or historical data associated with a previous communication session, the central controller determines whether a fourth communication session participant should be added 13 to the current communication session. The central controller may select the fourth communication session participant based on the attributes of possible communication session participants, or based on a request from another communication session participant. In this case the fourth communication session participant may be a mediator.

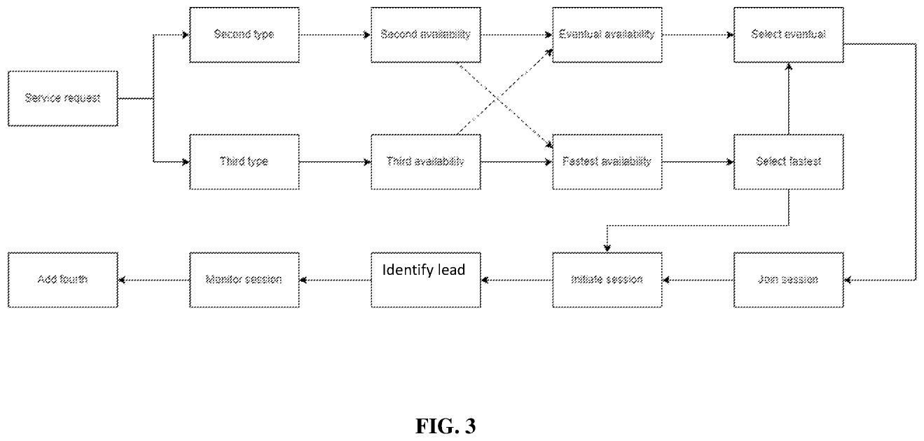

In FIG. 3 there is illustrated another data processing system according to the invention in use, which is similar to the data processing system of FIG. 1, and the data processing system of FIG. 3 operates in a similar manner to the description above.

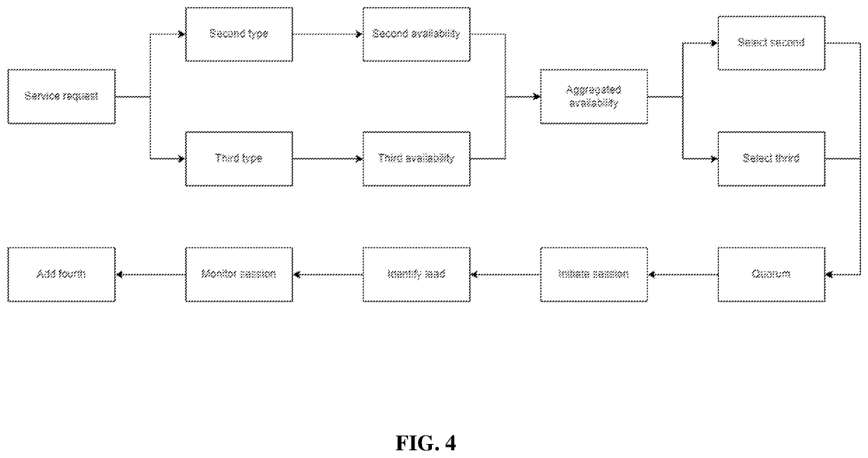

FIG. 4 illustrates another data processing system according to the invention in use, which is similar to the data processing system of FIG. 1, and the data processing system of FIG. 4 operates in a similar manner to the description above.

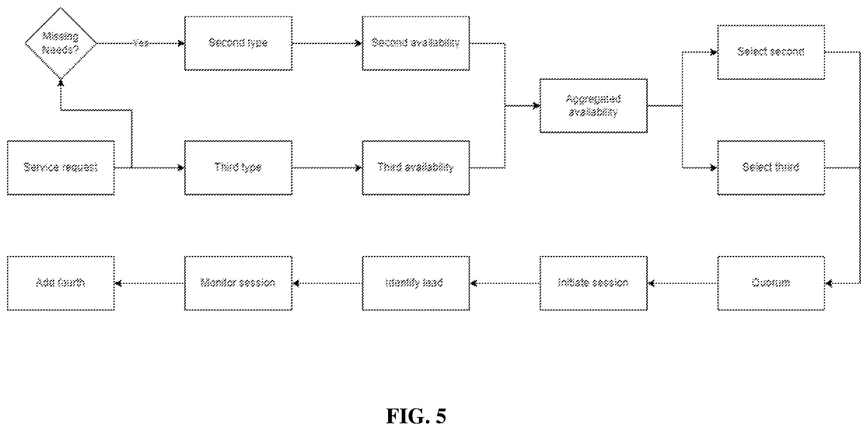

Referring to FIG. 5 there is illustrated another data processing system according to the invention in use, which is similar to the data processing system of FIG. 1, and the data processing system of FIG. 5 operates in a similar manner to the description above.

Throughout the description and claims of this patent specification, the words “comprise” and “contain” and variations of them mean “including but not limited to” and they are not intended to and do not exclude other moieties, additives, components, integers or steps. Throughout the description and claims of this patent specification, the singular encompasses the plural unless the context otherwise requires. In particular, where the indefinite article is used, the patent specification is to be understood as contemplating plurality as well as singularity, unless the context requires otherwise.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

Features, integers, characteristics or groups described in conjunction with a particular aspect, embodiment or example of the invention are to be understood to be applicable to any other aspect, embodiment or example described herein unless incompatible therewith. All of the features disclosed in this patent specification including any accompanying claims, abstract and drawings, and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this patent specification including any accompanying claims, abstract and drawings, or to any novel one, or any novel combination, of the steps of any method or process so disclosed.

What is claimed is:

1. A computer-implemented method for establishing a remote communication session, the method comprising the steps of:
receiving a service request message from a first communication session participant,
determining a second communication session participant and a third communication session participant based on the service request message, and
initiating a communication session between the first communication session participant, the second communication session participant, and the third communication session participant.

2. A method as claimed in claim 1 wherein the method comprises the step of selecting the second communication session participant from a second queue of possible communication session participants.

3. A method as claimed in claim 2 wherein the method comprises the step of determining a second availability parameter for each possible communication session participant in the second queue.

4. A method as claimed in claim 1 wherein the method comprises the step of selecting the third communication session participant from a third queue of possible communication session participants.

5. A method as claimed in claim 4 wherein the method comprises the step of determining a third availability parameter for each possible communication session participant in the third queue.

6. A method as claimed in claim 5 wherein the method comprises the step of determining an aggregated availability parameter for each possible combination of communication session participant in the second queue and communication session participant in the third queue based on the second availability parameters and the third availability parameters.

7. A method as claimed in claim 6 wherein the second communication session participant is selected and the third communication session participant is selected based on the aggregated availability parameter.

8. A method as claimed in claim 1 wherein the method comprises the step of:
determining if a pre-defined quorum of communication session participants has been reached, and
responsive to the pre-defined quorum being reached, initiating the communication session.

9. A method as claimed in claim 1 wherein the method comprises the step of determining one of the first communication session participant, the second communication session participant, and the third communication session participant to act as a lead communication session participant.

10. A method as claimed in claim 1 wherein the first communication session participant comprises a customer.

11. A method as claimed in claim 1 wherein the second communication session participant has a second attribute to perform a second type of service task.

12. A method as claimed in claim 1 wherein the third communication session participant has a third attribute to perform a third type of service task, the third type of service task being different to the second type of service task.

13. A method as claimed in claim 12 wherein the attribute comprises an authorisation level.

14. A method as claimed in claim 12 wherein the attribute comprises a skill.

15. A method as claimed in claim 1 wherein the second communication session participant comprises at least one of a bank teller, a supervisor, a customer service representative, an interpreter, an automated machine, a machine learning tool, or a computer program.

16. A method as claimed in claim 1 wherein the method comprises the step of determining a fourth communication session participant to be added to the communication session.

17. A method as claimed in claim 16 wherein the fourth communication session participant is determined based on at least one of data associated with the communication session, or historical data associated with a previous communication session.

18. A method as claimed in claim 16 wherein the fourth communication session participant comprises a mediator.

19. A data processing system for establishing a remote communication session, the system comprising a processor configured to:
receive a service request message from a first communication session participant,
determine a second communication session participant and a third communication session participant based on the service request message, and
initiate a communication session between the first communication session participant, the second communication session participant, and the third communication session participant.

20. A computer program product stored on a non-transitory computer readable storage medium, the computer program product comprising instructions capable of causing a computer system to perform a method as claimed in claim 1 when the computer program product is executed on the computer system.
